(19) United States
(12) Patent Application Publication
(10) Pub. No.: US 2017/0032432 A1
(43) Pub. Date: Feb. 2, 2017

(54) Integrated System

(71) Applicant: SAP SE, Walldorf (DE)

(72) Inventors: Artur Kaufmann, Landau (DE); Beate Schwenk, Heidelberg (DE); Uwe Reiner Scharf, Wiesloch (DE); Joerg Hans Richard Luther, Walldorf (DE)

(21) Appl. No.: 14/812,120

(22) Filed: Jul. 29, 2015

(51) Int. Cl. G06Q 30/04

(52) U.S. Cl. CPC G06Q 30/04

(57) ABSTRACT

The embodiments described herein relate to an improved invoicing system that is configured to integrate multiple heterogeneous billing streams from utility and non-utility related services into a single invoice document. At least certain embodiments are configured to receive consumption data for utility related services and generate billing information that reflects the quantity and price of the utilities consumed by a consumer based on the utility consumption data, receive consumption data for non-utility related services and aggregate billable items from the consumption data, generate billing information that reflects the quantity and price of each of the billable items for non-utility related services, and generate, using a master invoicing engine, an integrated invoice comprising consolidated billing information for both the utility related services and non-utility related services.

### FIELD OF THE INVENTION

At least certain embodiments disclosed herein relate generally to electronic systems, and more particularly to an integrated invoicing system.

### BACKGROUND

Industry-specific components exist for invoicing utility related services for utility companies to group utility related services and invoice them on one bill. Such a system may be designed for mass creation of consumption bills. However, such invoicing systems are not designed for rating non-utility related services. To deal with utility related and non-utility related services, utility companies conventionally have had to establish separate invoicing mechanisms that must be operated in parallel to generate and process separate invoices. Two separate bills must then be dispatched to the customers with increased postal charges. In addition, the two different correspondence solutions require maintenance of two bill forms. Such high system operating effort, high demands on hardware, and high training effort for managing two invoicing solutions will generally cause low acceptance among customers.

### SUMMARY

The embodiments and techniques described herein relate to an improved invoicing system that is configured to integrate multiple billing streams from utility and non-utility related services into a single invoice document. At least certain embodiments are configured to receive consumption data relating to a consumer's consumption of services provided by one or more service providers, determine whether the consumption data includes utility consumption data for utility services provided by A utility services provider, and generate utilities billing information that reflects the quantity and price of utility services consumed by the consumer based on the utility consumption data when the consumption data includes utility consumption data. And when the consumption data does not include utility consumption data, embodiments are configured to aggregate billable items from the consumption data, and generate convergent billing information that reflects the quantity and price for each of the billable items. A master invoicing engine can then generate an integrated invoice comprising consolidated billing information for both the utility related services and non-utility related services.

In one embodiment, the master invoicing engine is an invoicing engine configured for invoicing utility related services that is modified to process the convergent billing information. The convergent billing information may be received in the form of a convergent billing document which is provided to the modified utility related master invoicing engine for processing of non-utility related items.

Embodiments further provide for printing a single bill comprising information from the integrated invoice. In various embodiments, the single bill can summarize different services from different service providers, the same service from different service providers, the same service provided to different consumers, different services from the same service provide, and/or multiple service-related events associated with the consumer.

A database (or other memory device or system) can be used to store the consolidated billing information. The consolidated billing information can be matched to one or more of the consumer's accounts and stored in one or more fields of the database corresponding to the consumer accounts. Additional consumption data received subsequently from the same or different services providers can also be matched to the consumers' accounts and provided in an integrated invoice.

In yet other embodiments, a system for integrating billing streams from heterogeneous sources is disclosed. The system includes a processor and a memory system coupled with the processor via an interconnect line. The system also includes a network interface configured to receive consumption data relating to a consumer's consumption of one or more services provided by one or more service providers.

Embodiments further include one or more billing units configured to determine whether the consumption data includes utility consumption data for utility related services provided by a utility services provider and to generate utilities billing information that reflects the quantity and price of utilities consumed by the consumer based on the utility consumption data when the consumption data includes utility consumption data.

And when the consumption data does not include utility consumption data, embodiments are configured to aggregate billable items from the consumption data and generate convergent billing information that reflects the quantity and price for each of the billable items. A master invoicing engine can then generate an integrated invoice comprising consolidated billing information for both the utility related services and non-utility related services.

The following detailed description and accompanying drawings provide a better understanding of the nature and advantages of the present invention.

### BRIEF DESCRIPTION OF THE DRAWINGS

For a better understanding of at least certain embodiments, reference will be made to the following detailed description, which is to be read in conjunction with the accompanying drawings.

FIG. 1A depicts an overview diagram of an example embodiment of a system for generating an invoice for utilities services.

FIG. 1B depicts a block diagram of an example embodiment of a system for generating an invoice for utilities services.

FIG. 2A depicts an overview diagram of an example embodiment of a system for generating a consolidated invoice for multiple different non-utility related services.

FIG. 2B depicts a block diagram of an example embodiment of a system for generating a consolidated invoice for multiple different non-utility related services.

FIG. 3 depicts a block diagram of an example embodiment of a integrated system adapted to consolidate billing streams from heterogeneous sources including utility related and non-utility related services.

FIG. 4 depicts a block diagram of an example embodiment of a data model implementation for use with embodiments of the integrated invoicing system described herein.

FIGS. 5A-5D depict example embodiments of a graphical display of consolidated invoice information for utility related and non-utility related services.

FIGS. 6A-6B depict an example embodiment of a process for consolidating billing streams from multiple sources including utility related and non-utility related services.

FIG. 7 depicts an example data processing system upon which the embodiments described herein may be implemented.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of the invention.

### I. GENERAL OVERVIEW

At least certain embodiments described herein relate to an improved invoicing system that is configured to integrate multiple billing streams from utility and non-utility related services into a single invoice document. The advantages of such a system are numerous. First, with the integration of the utility related and non-utility related services in one invoicing system, only one correspondence solution is needed and the postal charges are directly decreased. This reduces the number of mass activities and time consuming batch processes, and less hardware resources are required.

Second, besides these obvious benefits, utility companies get new opportunities to do business in different sectors or cross-sectors. Utility companies are enabled to build new services—utility related and/or cross sectoral—and have the chance to develop new product bundles with short time-to-market. Such cross-sectoral services may include, for example, billing services for prepaid meters, billing for utility related sales and consulting services, billing of sales and marketing efforts, billing of concessions and licenses, online ticketing, and billing for Internet downloads, etc.

The consumer acceptance for the products and services can be increased by transitioning to such this more flexible system. In addition, the techniques described herein can be introduced without disruption or destabilization of the existing utility related invoicing systems. That is, the data exchange mechanisms and market communication processes already existing in utility invoicing systems can remain the same.

The integrated invoicing system described herein attempts to group as many source documents associated with a particular consumer's contract account as possible to be provided in one invoicing solution. The utility related and non-utility related invoicing processes, as well as the associated billing documents, can be grouped together and processed within one master invoicing unit. The resulting invoicing print document can contain individual print document lines with a reference to the included utility related and non-utility related billing documents to create the joint bill.

The common invoicing print document can be displayed in a graphical display of the integrated invoicing system. When the utilities billing document is displayed, the convergent invoicing document items as well as the processed billable items can also be displayed.

### II. EXEMPLARY SYSTEMS

Provided below is a description of an example system upon which the embodiments described herein may be implemented. Although certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner.

In addition, hardwired circuitry may be used independently or in combination with software instructions to implement the techniques described herein. For instance, the described functionality may be performed by specific hardware components containing hardwired logic for performing operations, or by any combination of custom hardware components and programmed computer components. The techniques described herein are not limited to any specific combination of hardware circuitry or software. Embodiments can also be practiced in distributed computing environments where tasks are performed by remote processing devices that are linked through one or more wire-based or wireless networks.

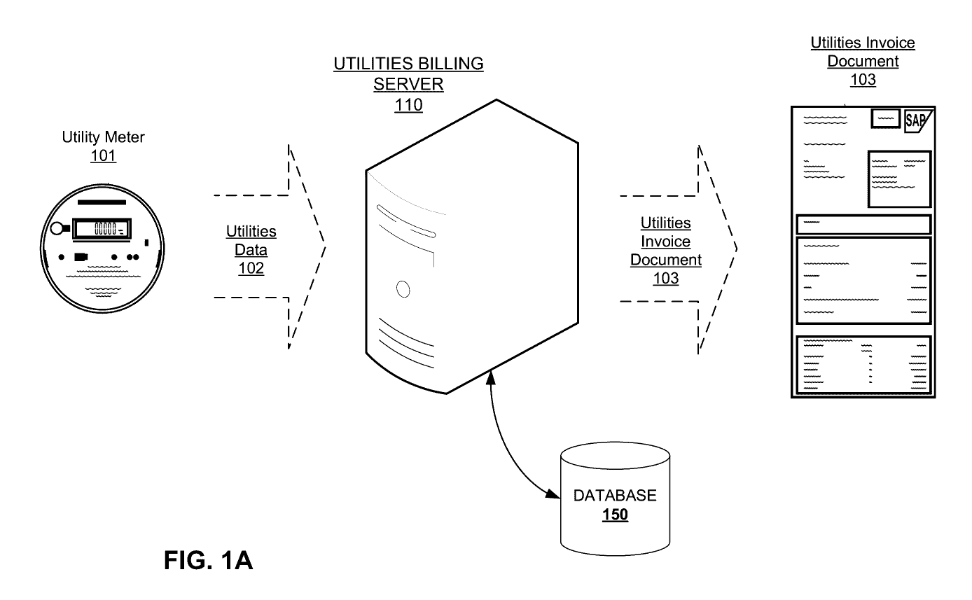

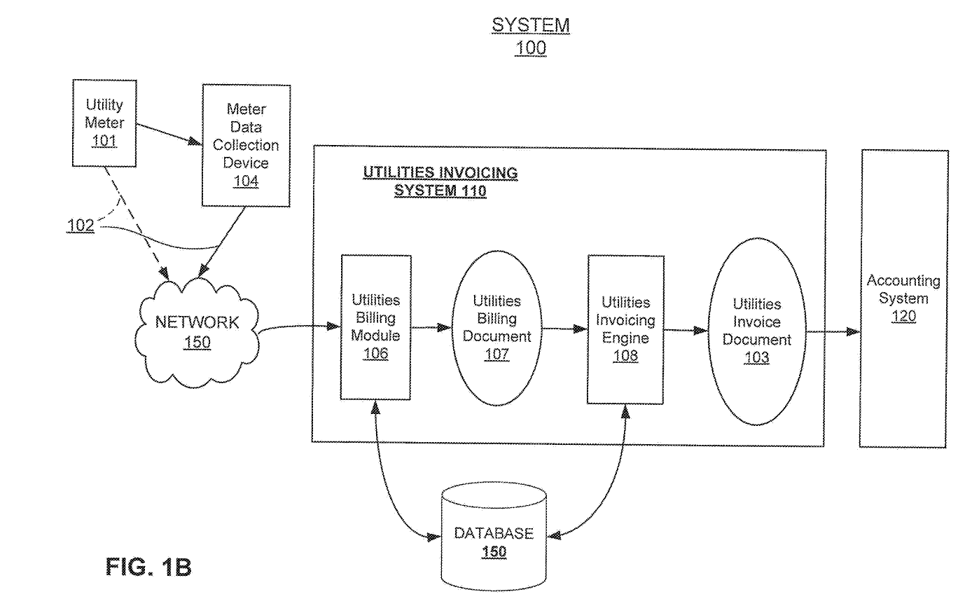

FIG. 1A depicts an overview diagram of an example embodiment of a system for generating an invoice for utilities services. In the illustrated embodiment, a utilities billing server 110 is configured to receive utilities data 102 obtained or collected from one or more utility meters 101. As used herein, the term “utility” generally refers to a utility organization, enterprise, or other entity that operates facilities used for the generation and transmission or distribution of power such as electricity, water or gas, etc. And a “utility meter” generally refers to a device located at a utility consumer's premises that measures consumption of utilities provided by a utilities service provider. A utility meter can include an electricity meter, an electric meter, a gas meter, a water meter, or generally any utility meter for measuring the amount of consumed by a residence, business, or other device or system. Utility companies typically use meters installed at their customers' premises to measure utilities (e.g., electricity, gas, water, etc.) delivered to their customers for billing purposes. They are calibrated in billing units, the most common one being the kilowatt-hour (kwh).

The utilities data 102 collected from meter 101 can be accomplished in several ways. One way is for local utilities meter reader personnel to come out to the customer's premises and take a reading from the meter on a monthly basis for example. The meter data 102 can then be entered into a third-party device configured for taking such measurements and for providing utilities data 102 based thereon. The third-party device can send the utilities data 102 to the utilities billing server 110 using any form of electronic messaging. As a few examples, the data format for the meter data 102 can include comma-separated values (“CSVs”) data format or Intermediate Documents (“IDocs”) data format. The embodiments described herein are not limited to any particular data format. In other embodiments, the utilities data 102 can be provided directly to the utilities billing server 110 via a suitable system or device, thus bypassing any third-party data collection devices, using the same or different data format types.

The utilities data 102 can be associated with a corresponding account of the utilities consumer and stored appropriately in one or more fields of database 150. Database 150 can include any type of database configured to store one or more sets of structured, semi-structured, or unstructured data, organized in one or more database fields, and that can be retrieved using queries from various data processing systems. For instance, database 150 can include a relational database, a distributed database, a structured or unstructured data store, or any combination thereof, etc. In one embodiment, database 150 is a component of the utilities billing server 110; in other embodiments, database 150 can be a device remote from the server 110, and may conduct communications with server 110 via one or more networks.

The utilities billing server 110 can be configured to process the utilities data 102 to generate the utilities invoice documents 103. The utilities billing server 110 can be any known computer server or other data processing system capable of processing utilities data 102.

FIG. 1B depicts a block diagram of an example embodiment of a system for generating an invoice for utilities services. In the illustrated embodiment, system 100 includes a utilities invoicing system 110 (e.g., server computer) configured for receiving utilities data 102 via a meter data collection device 104 or directly from the utility meter 101 over one or more networks 150 via one or more network ports or interfaces.

As will be appreciated, network 150 can be any wired or wireless network. For example, the networks described herein can be implemented as a local area network (“LAN”), wide-area network (“WAN”), combination of LANs and WANs, the Internet, or any other type of communication network adapted for exchanging electronic messages and information. The networks can be implemented as a physical array of hardware resources or as a virtual array, or any combination thereof; they can also be implemented in a cloud-based configuration. For example, the networks described herein can be implemented as a public or private cloud network or combination thereof. No specific network or network architecture should be construed as limiting the embodiments described herein.

The meter data 102 can be received at the one or more network interfaces (not shown) of the utilities invoicing system 110 and provided to a utilities billing module 106 where the meter data can be converted into a utilities billing document 107. The utilities billing document 107 can include a collection of electronic information and a number of fields for storing utilities data 102. For example, the fields of the utilities billing document 107 can include (1) a contract account number associated with the consumer, (2) one or more billing account numbers associated with the contract account number, (3) the quantity of utilities consumed by the consumer, (4) the price of each unit of utilities consumed, and (5) the amount payable for the utilities consumed. The utilities billing document 107 may also include a posting date, due date and a billing document number.

As used herein, the term “billing account” refers to a master data object that can be compared with a contract, stating which kind of services offered in a certain time period at a given price. Whereas a contract may contain additional data such as legal agreements, a billing account only focuses on billing-relevant data such as the type of service (for example, phone service or tolls), the billing schedule, and the rate that applies for billing. A “contract account” on the other hand refers to a structured element of contract accounts receivable and payable for data entry and reporting of all receivables and payables of one or more companies to one or more business partners. It contains guidelines and agreements with regard to one or more business partners concerning payment, interest calculation, and tax calculation for receivables and payables, etc.

A billing account is generally assigned to a contract account. A contract account may have multiple billing accounts for multiple items. A contract account may also have different billing accounts for different services.

The utilities billing module 106 may access database 150 to determine what consumer contracts and billing accounts are associated with the consumed utility services. The utilities billing module 106 may also store the utilities data 102 along with the utilities billing document 107 in one or more appropriate fields of the database 150 associated with one or more accounts of the consumer.

In FIG. 1B the utilities billing document 107 is input into a utilities invoicing engine 108 of the utilities invoicing system 110. The utilities billing document 107 can be converted into an invoice for utility services by the utilities invoicing engine 108, which can then be printed as a utilities invoice document 103. Database 150 may be queried by the utilities invoice engine 108 for consumer data and account numbers in preparing the print invoice document 103. This information can also be passed to an accounting system 120 for accounts payable and receivable processing and for sending out the printed (or electronic) invoice documents 103 to the consumer.

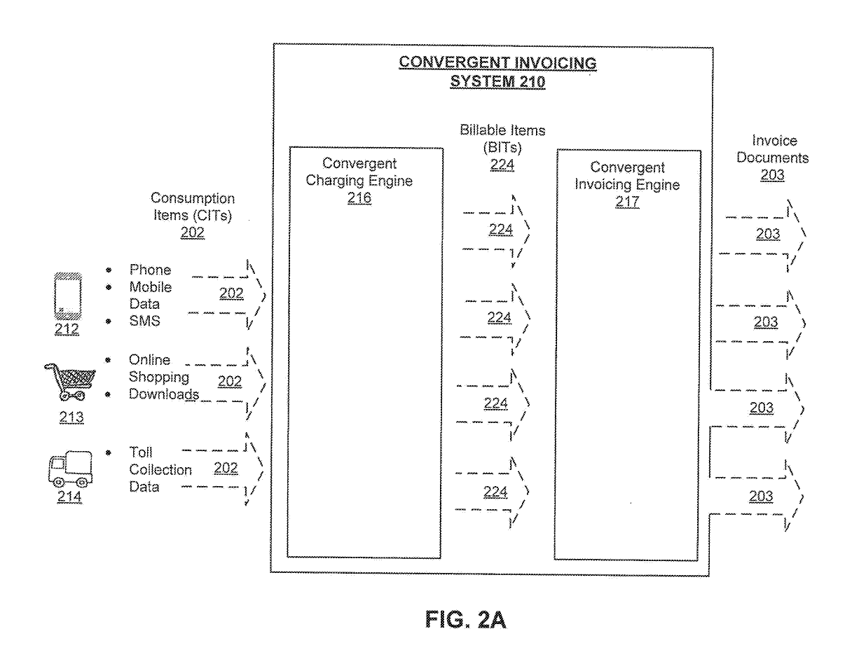

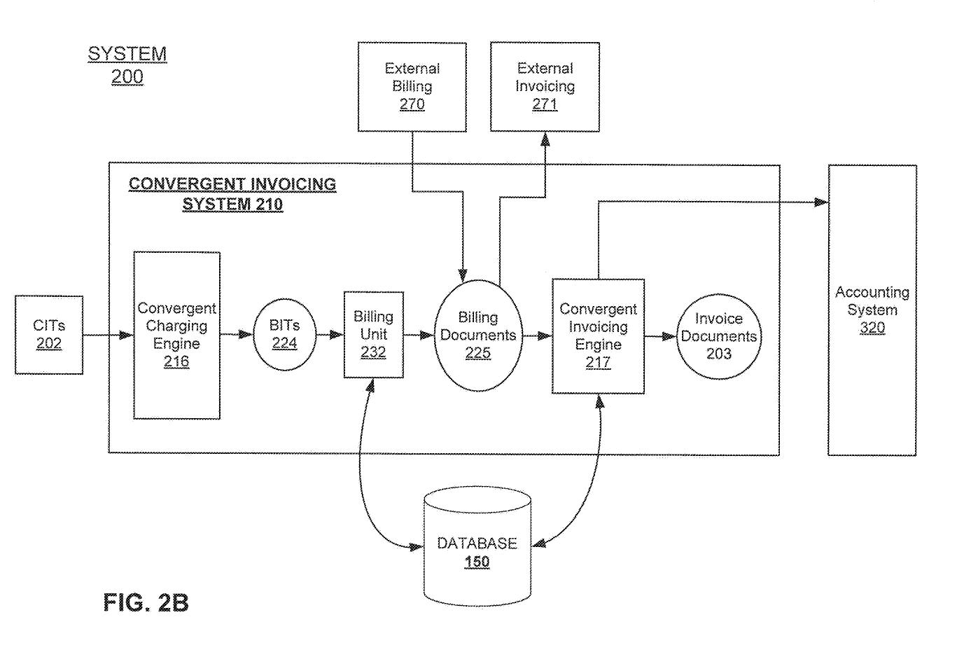

FIG. 2A depicts an overview diagram of an example embodiment of a system for generating a consolidated invoice for multiple different non-utility related services. Various non-utility related services may be consumed by the consumer from multiple different sources. In the illustrated embodiment, these services include phone, mobile data, and SMS services 212, online shopping and download services 213, and toll collection services 214. Other types of non-utility related services are possible (pre/postpaid, fixed-mobile, Internet, TV, etc.)—the embodiments described herein are not limited to any particular service or service offerings.

The services 212-214 provide services to consumers which can be captured as “consumption events” and communicated to the convergent invoicing system (e.g., computer server) 210 as one or more “consumption items” (“CITs”) 202 that can be generated based on the consumption events. For example, a consumer may purchase a product or service online and a consumption event may be generated that includes one or more CITs 202 that can be billed to the consumer. The CITs 202 can be communicated to the convergent invoicing system 210 for processing into an invoice for non-utility related services to be sent out to the consumer.

In the illustrated embodiment, a convergent charging engine 216 of the convergent invoicing system 210 is configured to receive the CITs 202. The CITs may be from a variety of different service providers and for a variety of different service types. The convergent invoicing system 210 is configured to handle the various different service types and associated data. The convergent charging engine 216 may include a rating unit (not shown) configured to charge the consumption of the consumer. For example, if the consumer makes a call to Germany, that call will run through the ratings unit and it will be determined the price of the call. The ratings unit within the convergent charging engine 216 can be configured to receive the CITs 202 and charge them to generate one or more billable items (“BITs”) 224 therefrom. The data format for the billable items can be, e.g., CSV, SOAP (XML over http), or uploaded via excel or RFC, etc.

The BITs 224 can be aggregated as billing information in a convergent billing document (not shown) that contains fields similar to those discussed above with respect to the utilities billing document. For example, the convergent billing document can include (1) one or more contract account numbers associated with the consumer, (2) one or more billing account numbers associated with each contract account number, (3) the quantity of BITs consumed, (4) the price of each BIT 224, and (5) the amount payable for the BITs 224 consumed. The convergent billing document may also include a posting date, due date and a billing document number.

For example, the service of interest may be a telecommunication service. The data included in such an example may include the number called, the calling number, the date/time of the call, the duration of the call, the time zone, location of the caller, postpaid/prepaid, etc. In another example, the service of interest may be a toll collection service, and the data may include place of toll collection, station number, date/time, distance to drive, car number, differentiation if it is a car or truck, number of wills in case of a truck, whether payment is by credit card, etc.

The data format of the CITs 202 and the BITs 224 can be in multiple different formats depending upon which service provider is providing the service and depending on the type of services provided. The data format of the various different CITs 202 and BITs 224 can be converted into a common data format for processing by the convergent invoicing system 210.

In the illustrated embodiment, convergent invoicing system 210 further includes a convergent invoicing engine 217. The convergent invoicing engine 217 can be configured to receive the convergent billing document (containing the BITs 224) and to generate an invoice document 203 based thereon. The invoice document 203 is based on the information provided in the convergent billing document. The invoice document 203 consolidates the BITs 224 from the various different non-utility related services into a single invoice that can be printed and provided to the consumer.

FIG. 2B depicts a block diagram of an example embodiment of a system for generating a consolidated invoice for multiple different non-utility related services. In the illustrated embodiment, system 200 includes a convergent invoicing system 210 (e.g., server computer) comprising a convergent charging engine 216, a billing unit 232, and a convergent invoicing engine 217. As discussed above, the convergent charging engine 216 is configured to receive CITs 202 from various service providers of different types and to convert them into BITs 224.

The BITs 224 are then provided to a billing unit 232, which is configured to generate billing documents 225 based on the BITs. The information in the BITs can be placed in various predefined data fields of the billing document 225 to be used later in generating integrated invoices according to the techniques described herein. The billing unit 232 can be configured to receive BITs 224, and upon receipt, to access database 150 to match the BITs 224 with contracting and billing accounts of the consumer based on the account numbers provided in the BITs. The billing information contained in the billing document can then be stored in database 150 in one or more fields corresponding to the accounts of the consumer. This information can then be later queried based on the account numbers of the consumer.

The billing documents 225 can then be provided from the billing unit 232 to the convergent invoicing engine 217, which is adapted to generate invoice documents 203 based on the billing documents 225. The invoice documents 203 can then be printed out into electronic or hard copy form and provided to the consumer. In at least certain embodiments, the invoice documents 203 may include information regarding (1) one or more contract account numbers associated with the consumer, (2) one or more billing account numbers associated with the consumer, (3) identifying information of the service provider(s), (4) the type of BITs consumed, (5) the quantity of BITs consumed, (6) the price of each of the BITs, and (7) the amount payable for the BITs consumed. The invoicing documents 203 may also include a posting date, a due date, and a document number.

In addition, external billing information 270 (e.g. external billing documents) can also be input to the convergent invoicing engine 217. In such cases, the convergent invoicing engine 217 can generate invoices 271 for use by external billing systems. For example, the external billing systems can include sales and distribution systems, consumer resource management (“CRM”) systems, or employment resource planning (“ERP”) systems, etc.

The techniques described herein are adapted to integrate the systems depicted in FIGS. 1B and 2B to provide a single invoice for both utility related and non-utility related services in a single invoice to be provided to the consumer. Businesses in the telecommunications, public transport, electronic toll collection, and postal services industries, for example, now enable customers to use their services without any need for human interaction. The respective services consumed can be rated and stored as event data records. These billable events are automatically recorded and documented in preparation for invoicing according to predetermined schedules (e.g., monthly).

In addition, rather than receive numerous invoices for individual services from one or more service providers, consumers can receive a single invoice from the providers that includes the total cost of services consumed within a given period, along with itemized overview of each of the individual services. Convergent invoices allow companies to present customers with a single bill that summarizes multiple users, multiple events, and sometimes multiple service providers.

For example, mobile phone services are typically purchased through a single provider; however, when services from the provider are not available, customers can use the service of a third-party provider through a process referred to as “roaming.” At the end of the month, consumers receive a single invoice even though they may have received service from their primary provider and other providers as they incurred roaming charges. This single convergent invoice can also include other services such as email, ring tones, and text messaging that may be offered by a number of outlets that contract with the primary service provider. And of course, there could be multiple phone lines on a single statement.

The convergent invoicing engine aggregates a number of services consumed by the customer into a single invoice as well as integrates the various systems used to provide those services. In another example, numerous governments are offering automotive toll collection services for private and commercial drivers. In most cases, these services require a transponder to be installed in the vehicle so that when it passes through a toll bridge, the tag is detected by roadside equipment that transmits a message to update a database with the new service record. Subsequently, those entries are checked and standardized, after which the event is rated in passed to an event data record database where it is stored. Through the convergent invoicing system, these billable events can be aggregated at the end of a billing cycle and invoices can be created and sent to the consumers.

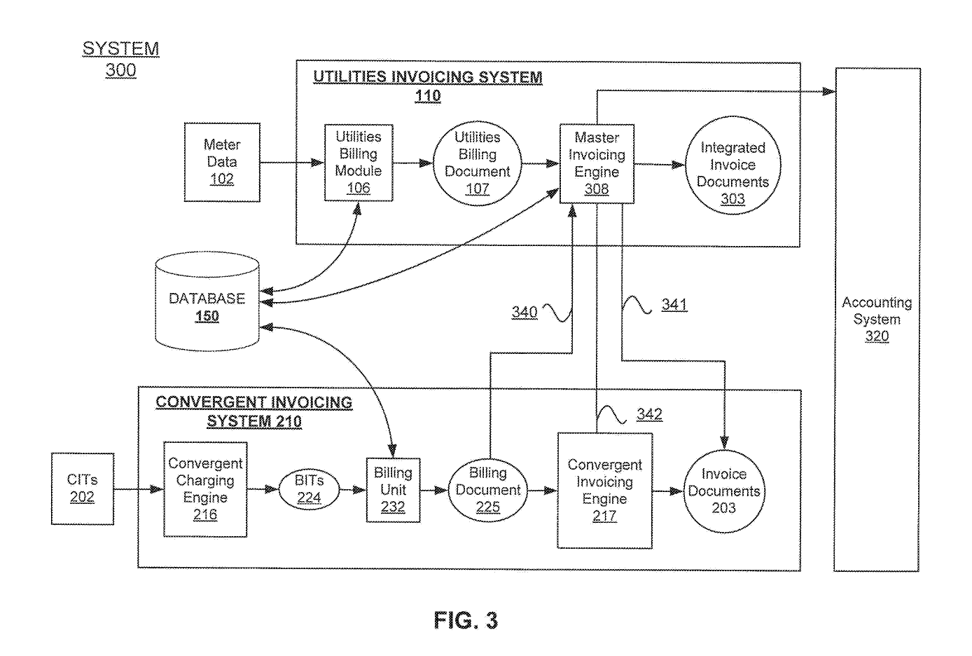

FIG. 3 depicts a block diagram of an example embodiment of a integrated system adapted to consolidate billing streams from heterogeneous sources including utility related and non-utility related services. In the illustrated embodiment, system 300 integrates the convergent invoicing system 210 of FIGS. 2A-2B with the utilities invoicing system 110 of FIGS. 1A-1B. A master invoicing engine 308 of the utilities invoicing system 110 is provided. Master invoicing engine 308 is configured to receive the billing documents 225 from the convergent invoicing system 210 and the utilities billing documents 107 and to convert them into an integrated invoice document 303. In one embodiment, the master invoicing engine 308 is a modified version of the utilities invoicing engine 108 of FIG. 1B configured for processing the convergent billing information in the convergent billing documents 225.

As shown, database 150 can be shared between the two invoicing systems 110 and 210. Database 150, however, can also be configured as multiple separate databases that are either included as components of the respective invoicing systems 110 and 210 or in remote communication with them, or any combination thereof. As discussed above, the billing unit 232 accesses database 150 to match the billable items 224 with one or more accounts of the consumer. Likewise the utilities billing module 106 accesses the database 150 to match the meter data 102 with one or more accounts of the consumer. This information is then used to generate the utilities billing documents 107 and the convergent billing documents, respectively. These billing documents are then provided to the master invoicing engine 308. In this embodiment, the convergent invoicing system 210 provides the billing documents 225 to the master invoicing engine 308 over one or more lines 340.

The master invoicing engine 308 can then query database 150 to match the information in the billing documents 107 and 225 with one or more accounts of the consumer. This information can then be used to generate the integrated invoice documents 303. The integrated invoice documents 303 can be printed out in electronic or hard copy form and provided to the consumer. In addition, the information contained in the integrated invoice documents 303 can be provided from the master invoicing engine 308 to an accounting system 324 for accounts payable and receivable processing. The information in the integrated invoice documents 303 can also be stored back in database 150 in the appropriate fields associated with the consumer's accounts.

The convergent invoicing engine 217 may be linked with the master invoicing engine 308 via a line 342. Information may be passed between these two invoicing engines 217 and 308 using this connection. In addition to generating the integrated invoice documents 303, the master invoicing engine 308 can also be configured to generate convergent invoicing documents 203 that can be linked with the integrated invoice document across line 341. As discussed above, the information contained in the integrated invoice documents 303 includes information from the convergent billing documents 225. In a preferred embodiment, this can be accomplished by linking the information from the convergent invoice document 203 with the integrated invoice document 303 via line 341.

In one embodiment, the system 300 is configured to receive consumption data relating to a consumer's consumption of services provided by one or more service providers and determine whether the consumption data includes utility consumption data for utility related services provided by a utility services provider. If the consumption data is utility consumption data, then a utilities billing document 107 comprising utilities billing information can be generated that reflects the quantity and price of utilities consumed by the consumer based on the utility consumption data. The utilities billing document can then be communicated to the master invoicing engine 308 to be converted into an integrated invoice document 303. If the consumption data does not include utility consumption data, the system 300 can be configured to aggregate billable items from the non-utility related consumption data and generate a convergent billing document 225 comprising convergent billing information that reflects the quantity and price for each of the billable items. The master invoicing engine 308 can then generate an integrated invoice 303 comprising consolidated billing information for both the utility related services and non-utility related services from the utilities billing document 107 and the convergent billing document 225 respectively.

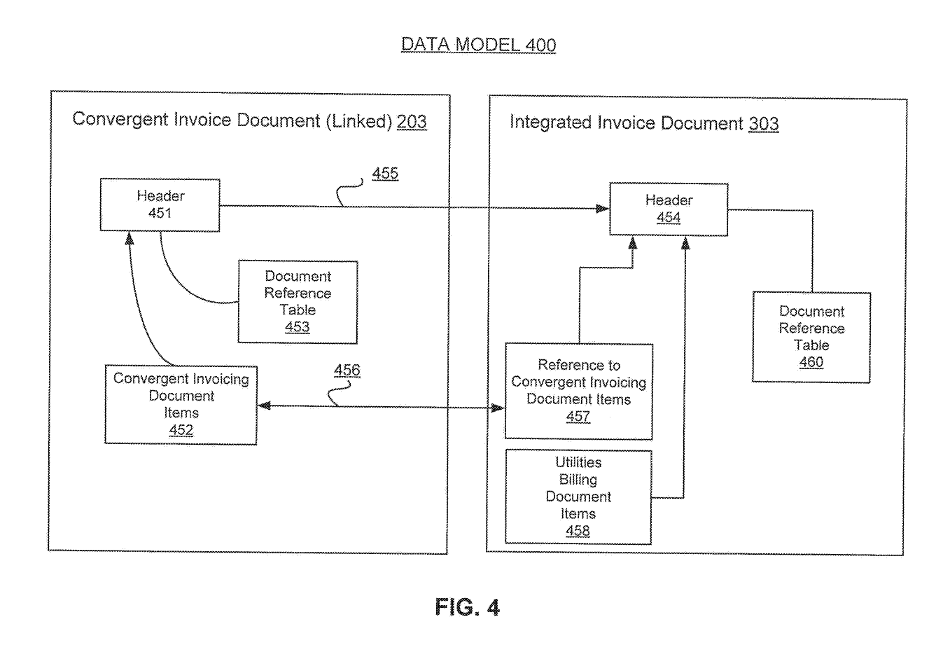

FIG. 4 depicts a block diagram of an example embodiment of a data model implementation for use with embodiments of the integrated invoicing system described herein. In the illustrated embodiment, data model 400 includes the integrated invoice document 303 linked to the convergent invoice document 203. In a preferred embodiment, the cardinality of the entries relation in data model 400 is one-to-one.

In one embodiment, the linked convergent invoice document 203 is a representative or “subordinate” document that is generated to link the convergent invoicing information with the utilities invoicing information. The master invoicing engine 303 can be adapted to generate the subordinate invoicing document 203. The integrated invoice document 303 is linked to the information referenced in the subordinate document 203. The subordinate document 203 can store references to the convergent invoicing information. The convergent invoicing document items 452 can then be accessed when generating the integrated invoice 303 via link 456.

In the illustrated embodiment, the linked convergent invoicing document 203 includes a header field 451, a document reference table 453, and convergent invoicing document items 452, and the integrated invoice document 303 includes a header 454, a document reference table 460, utilities billing document items 458, and a reference to the convergent invoicing document items 457. The integrated invoice header field 454 is linked to the header field 451 of the convergent invoice document 203 via link 455. In one embodiment, the convergent invoice document number can be included in the integrated invoice document header field 454. Inversely, the integrated invoice document number can be stored as a reference document number in the convergent invoice document header field 451.

The reference table for the convergent invoicing document items 457 in the integrated invoice document 303 can be linked to the convergent invoicing document items 452 via link 456. This link allows the information in the convergent invoicing document items 452 to be accessed by the integrated invoice document 303 via a reference table 457. That is, the integrated invoice document items are linked to the convergent invoicing document items 452 using the reference tables 457. As mentioned above, the linked convergent invoice document 203 can be considered as a subordinate document that depends on the information in the integrated invoice document 303. A target process may not only be stored in the convergent invoicing document header 451 to indicate which invoicing process is responsible for processing the source document, but also may be added as a new field to the integrated invoice document header 454.

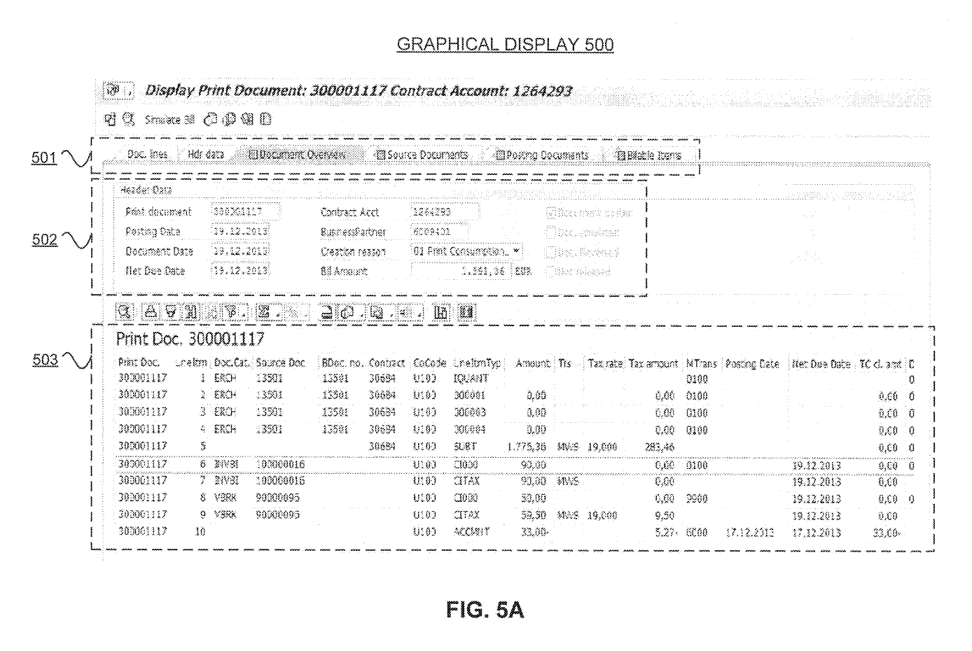

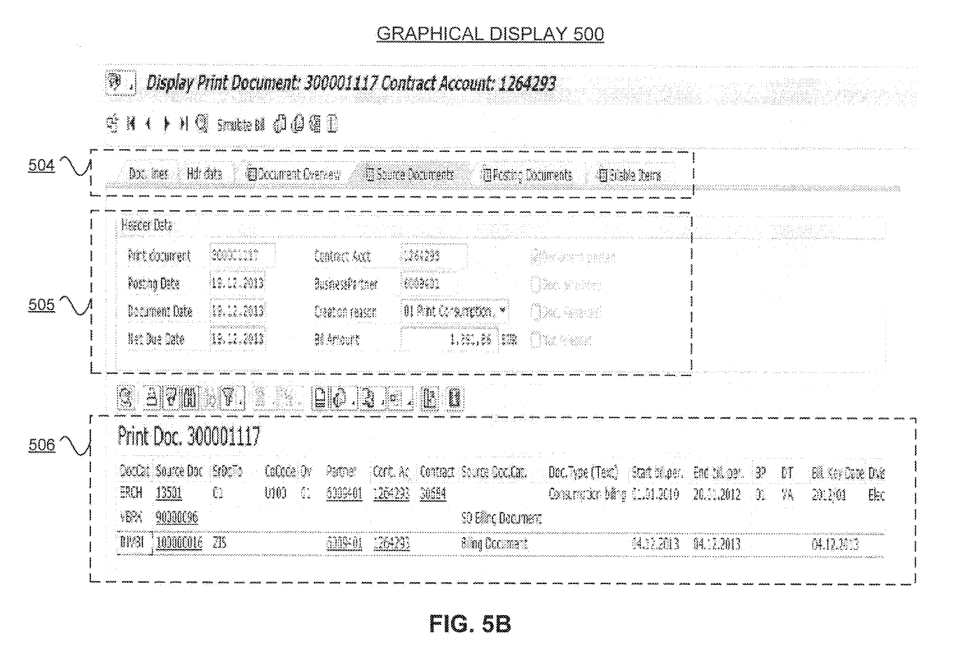

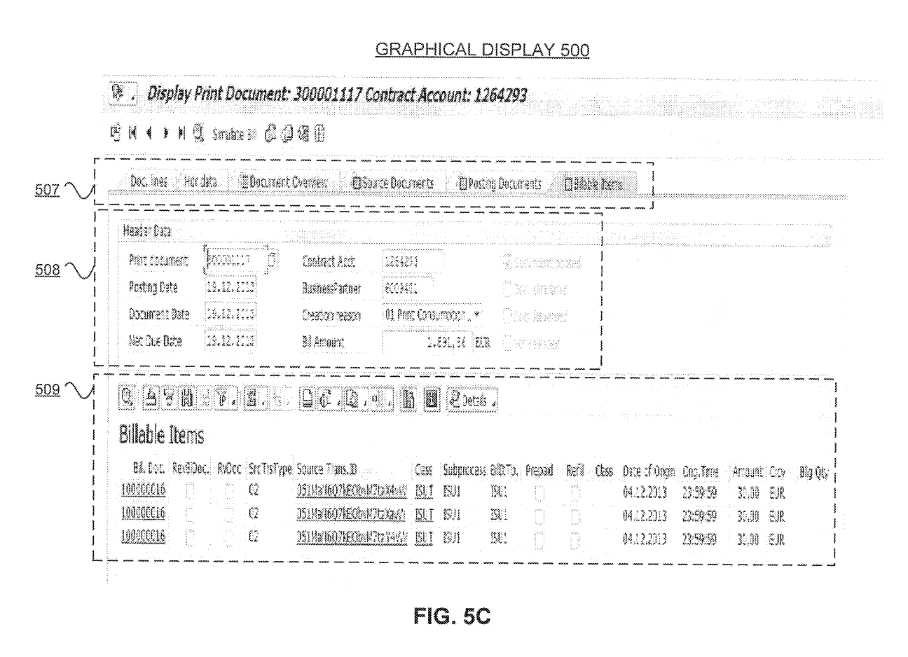

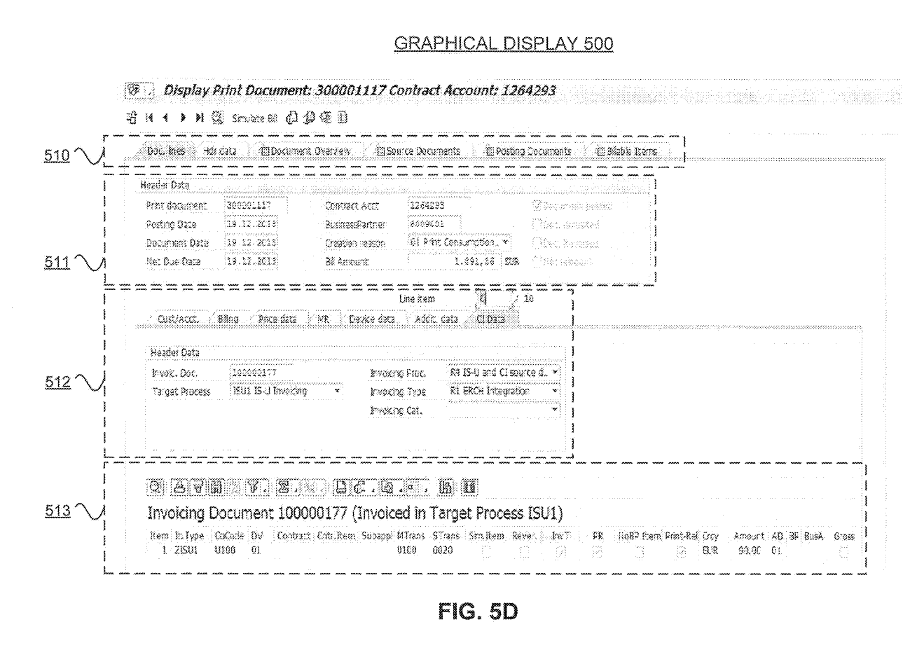

FIGS. 5A-5D depict example embodiments of a graphical display of consolidated invoice information for utility related and non-utility related services. In the illustrated embodiment of FIG. 5A, graphical display 500 includes information displayed to a user. This information can include selection tabs 501 for navigating information in the integrated invoice. In the illustrated embodiment, the selection tabs include a “Document Overview” tab, a “Source Document” tab, a “Billable Items” tab, a “Document Lines” tab, and other tabs for navigating the information contained in the integrated invoice document. In FIG. 5A, the “Document Overview” tab has been selected.

In the document overview the Header Data 502 is displayed. Header data 502 provides information including, for example, the print document (integrated invoice) number, the contract account number, posting date, business partner number, document date, creation reason, due date, and billing amount. Graphical display 500 also displays line items information 503 for each of the line items of utility related and non-utility related services referenced in the integrated invoice document.

In the illustrated embodiment of FIG. 5B, the “Source Documents” tab is selected from information 504 to display information relating to the documents containing source information for the integrated invoice document. Header data 505 provides information including, for example, the print document (integrated invoice) number, the contract account number, posting date, business partner number, document date, creation reason, due date, and billing amount. Information 506 is also displayed including information depicting the document category and corresponding source document numbers, source document category, document type, billing period, business partner number, contract account number, etc.

In the illustrated embodiment of FIG. 5C, the “Billable Items” tab is selected from information 507 to display information relating to the billable items for each integrated billing document(s). Header data 508 provides information including, for example, the print document (integrated invoice) number, the contract account number, posting date, business partner number, document date, creation reason, due date, and billing amount. Information 509 is also displayed including information depicting billable items information including billing document number, source transmission ID, class, sub-process, date and time of origin, payment amount, currency, etc.

In the illustrated embodiment of FIG. 5D, the “Doc. Lines” tab is selected from information 510 to display information relating to the integrated invoice document. Header data 511 provides information including, for example, the print document (integrated invoice) number, the contract account number, posting date, business partner number, document date, creation reason, due date, and billing amount. Information 512 and 513 are also displayed including information depicting invoice document number, target process (i.e., utilities invoicing), invoicing process, invoicing type, and further details of the invoicing document invoiced in the target process.

### III. EXEMPLARY PROCESSES

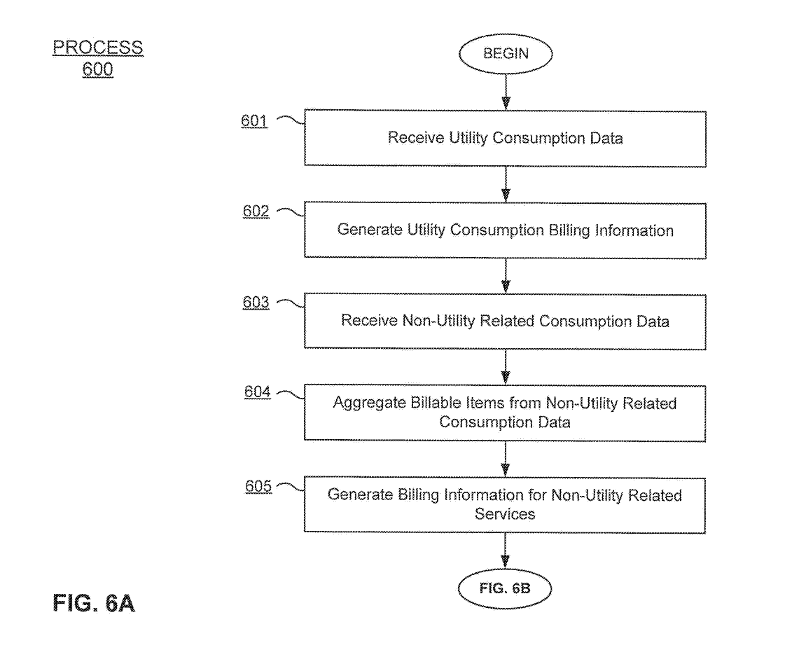

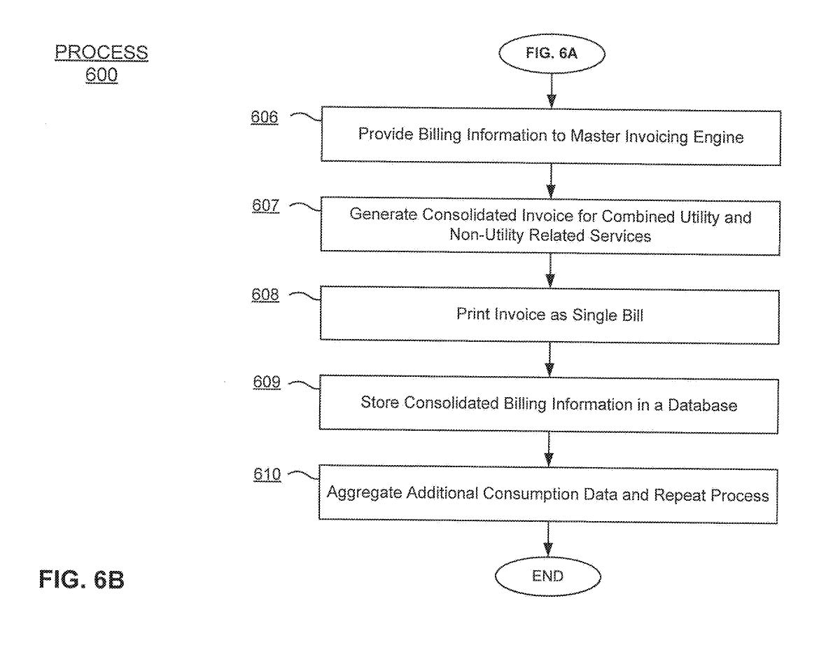

FIGS. 6A-6B depict an example processes for integrating billing streams from heterogeneous sources including utility related and non-utility related services according to one embodiment. It is noted that the processes described below are exemplary in nature and are provided for illustrative purposes and not intended to limit the scope of the invention to any particular example embodiment. For instance, methods in accordance with some embodiments described herein may include or omit some or all of the operations described below, or may include steps in a different order than described herein. The particular methods described are not intended to be limited to any particular set of operations exclusive of all other potentially intermediate operations.

In addition, the operations may be embodied in computer-executable code, which causes a general-purpose or special-purpose computer to perform certain functional operations. In other in stances, these operations may be performed by specific hardware components or hardwired circuitry, or by any combination of programmed computer components and custom hardware circuitry.

In the illustrated embodiment, process 600 begins by receiving utility consumption data of a consumer (e.g., collected from a utility meter) for utility related services of an utility services provider (operation 601) and generating utilities billing information that reflects the quantity and price of utilities consumed by the consumer based on the utility consumption data (operation 602).

Process 600 continues by receiving consumption data for various non-utility related services, wherein the consumption data is for various different types of non-utility related services or for the same type of services from different service providers, or the same services provided to multiple different consumers (operation 603). The non-utility services can be represented as billable items which can be aggregated (operation 604) to generate convergent billing information for the non-utility related services (operation 605) that reflects the quantity and price for each of the billable items. In one embodiment, the utilities billing information can be included in data fields of a utilities billing document and the convergent billing information can be included in data fields a convergent billing document. In such cases, the data fields of the utilities billing document and the convergent billing document can be merged to generate the integrated invoice.

As discussed above, the received consumption data for utility related and non-utility related services can be in a format different from the data format internal to the integrated invoicing system. In such cases, the data format of the consumption data can be converted into a common data format for processing by the integrated invoicing engine.

Control of process 600 continues on FIG. 6B where the billing information for the utility related and non-utility related services is provided (e.g., via billing documents discussed above) to a master invoicing engine (operation 606). In one embodiment, the master invoicing engine is a utilities invoicing engine that has been modified to process the billing information from the convergent billing documents. The master invoicing engine can then generate an integrated invoice comprising consolidated billing information from the utilities billing information and the convergent billing information (operation 607) and generate a print invoice document as a single bill provided to the consumer (operation 608).

The consolidated billing information can then be stored in a database (operation 609), which can be any known database as discussed above. The consolidated billing information can be stored in one or more fields of a database corresponding to one or more accounts corresponding to the consumer. Additional consumption data can be subsequently received, aggregated, and the process repeated as appropriate (operation 610). This completes process 600 according to one example embodiment.

### IV. EXEMPLARY HARDWARE IMPLEMENTATION

Embodiments of the present invention may be practiced using various computer systems including hand-held devices, microprocessor systems, programmable electronics, laptops, tablets and the like. The embodiments can also be practiced in distributed computing environments where tasks are performed by remote processing devices that are linked through one or more wire-based or wireless networks.

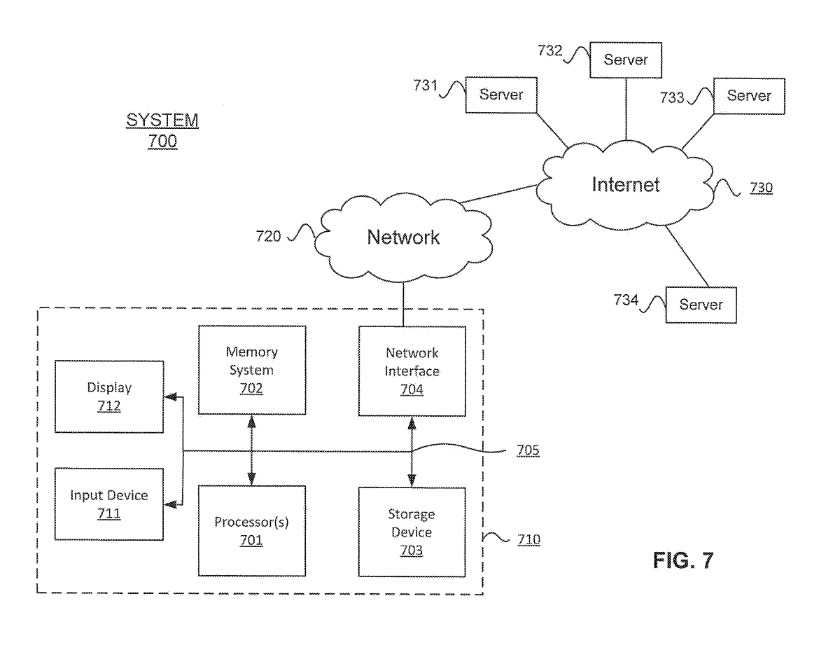

FIG. 7 illustrates an example block diagram of a data processing system upon which the embodiments described herein may be implemented. The following hardware description is merely one example. It is to be understood that a variety of computers configurations may be used to implement the described techniques. While FIG. 7 illustrates various components of a data processing system 700, it is not intended to represent any particular architecture or manner of interconnecting components. It will also be appreciated that network computers and other data processing systems, which have fewer components or additional components, may be used. The data processing system 700 may, for example, comprise a personal computer (PC), workstation, laptop computer, tablet, smartphone or other hand-held wireless device, or any device having similar functionality.

In the illustrated embodiment, data processing system 700 includes a computer system 710. Computer system 710 includes an interconnect bus 705 (or other communication mechanism for communicating information) and one or more processor(s) 701 coupled with the bus 705 for processing information. Computer system 710 also includes a memory system 702 coupled to bus 705 for storing information and instructions to be executed by processor 701, including information and instructions for performing the techniques described above. This memory system may also be used for storing programs executed by processor(s) 701. Possible implementations of this memory system may be, but are not limited to, random access memory (RAM), read only memory (ROM), or combination thereof.

In the illustrated embodiment, a storage device 703 is also provided for storing information and instructions. Typically storage device 703 comprises nonvolatile memory. Common forms of storage devices include, for example, a hard drive, a magnetic disk, an optical disk, a CD-ROM, a DVD, a flash or other non-volatile memory, a USB memory card, or any other computer-readable medium from which a computer can read data and instructions. Storage device 703 may store source code, binary code, or software files for performing the techniques above. In addition, while FIG. 7 shows that storage device 703 as a local device connected with the components of the data processing system, it will be appreciated by skilled artisans that the described techniques may use a storage device remote from the system, such as a database or other network storage device coupled with the computer system 710 through a network interface such as network interface 704.

Network interface 704 may provide two-way data communication between computer system 710 and a network 720. The network interface 704 may be a wireless or wired connection. Computer system 710 is configured to send and receive information through the network interface 704 across one or more networks 720 such as a local area network (LAN), wide-area network (WAN), wireless or Bluetooth network, or the Internet 730, etc. A may access data and features on systems residing on one or multiple different hardware servers 731-734 across the network 720. Hardware servers 731-734 and associated server software may also reside in a cloud computing environment.

Storage device and memory system are both examples of non-transitory computer readable storage media. Embodiments herein can be implemented in computer-readable code stored on any computer-readable medium, which when executed by a computer or other data processing system, can be adapted to cause the system to perform operations according to the techniques described herein. Computer-readable media may include any mechanism that stores information in a form accessible by a data processing system or device such as a computer, network device, tablet, smartphone, or any device having similar functionality. Examples of computer-readable media include any type of non-transitory, tangible media capable of storing information thereon, including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing data and instructions in an electronic format. Computer-readable media can also be distributed over a network-coupled computer system stored and executed in a distributed fashion.

Further, computer system 710 may be coupled via bus 705 to a display 712 for displaying information to a computer user. An input device 711 such as a keyboard, touchscreen, and/or mouse is coupled to bus 705 for communicating information and command selections from the user to processor 701. The combination of these components allows the user to communicate with the system. In some systems, bus 705 represents multiple specialized buses.

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a computer system. The techniques may be carried out in a computer system or other data processing system in response executing sequences of instructions stored in memory.

Throughout the foregoing description, for the purposes of explanation, numerous specific details were set forth in order to provide a thorough understanding of the invention. It will be apparent, however, to persons skilled in the art that these embodiments may be practiced without some of these specific details. The above examples and embodiments should not be deemed to be the only embodiments, and are presented to illustrate the flexibility and advantages of the present invention. Other arrangements, embodiments, implementations and equivalents will be evident to those skilled in the art and may be employed without departing from the spirit and scope of the invention as defined by the following claims.

What is claimed is:

1. A method for integrating billing streams from heterogeneous sources comprising:
receiving consumption data relating to a consumer's consumption of services provided by one or more service providers;
determining whether the consumption data includes utility consumption data for utility related services provided by a utility services provider;
generating utilities billing information that reflects the quantity and price of utilities consumed by the consumer based on the utility consumption data when the consumption data includes utility consumption data;
performing the following when the consumption data does not include utility consumption data:
(1) aggregating billable items from the consumption data, wherein the consumption data includes first consumption data from a first provider of non-utility related services and from second consumption data from a second provider of non-utility related services different from the first consumption data; and
(2) generating convergent billing information that reflects the quantity and price for each of the billable items; and
generating, using a master invoicing engine, an integrated invoice comprising consolidated billing information from the utilities billing information and the convergent billing information.

2. The method of claim 1 wherein the master invoicing engine is an invoicing engine for utility related services that is modified to process the convergent billing information.

3. The method of claim 1 further comprising:
matching the consolidated billing information to an account of the consumer; and
storing the consolidated billing information in one or more fields of a database corresponding to the account of the consumer.

4. The method of claim 1 further comprising printing a single bill comprising information from the integrated invoice.

5. The method of claim 4 wherein the single bill summarizes the same services provided by different service providers or different services provided by the same service provider, or the same service provided to multiple different consumers.

6. The method of claim 1 further comprising converting data format of the first consumption data and the second consumption data for non-utility related services into a common data format.

7. The method of claim 1 further comprising:
generating a utilities billing document from the utilities billing information; and
generating a convergent billing document from the convergent billing information.

8. The method of claim 7 further comprising:
generating a subordinate document that stores references to the billing information in the convergent billing document; and
linking the integrated invoice to the billing information referenced in the subordinate document.

9. The method of claim 8 further comprising:
linking a header of the integrated invoice to a header of the subordinate document; and
storing a document number of the convergent billing document in the integrated invoice header.

10. The method of claim 9 further comprising storing a document number of the integrated invoice as a reference document number in the subordinate document header.

11. A system for integrating billing streams from heterogeneous sources comprising:
a processor;
a memory coupled with the processor via an interconnect line;
a network interface unit configured to receive consumption data relating to a consumer's consumption of one or more services provided by one or more service providers;
one or more billing units configured to:
determine whether the consumption data includes utility consumption data for utility related services provided by a utility services provider;
generate utilities billing information that reflects the quantity and price of utilities consumed by the consumer based on the utilities consumption data when the consumption data includes utility consumption data;
perform the following when the consumption data does not include utility consumption data:
(1) aggregate billable items from the consumption data, wherein the consumption data includes first consumption data from a first provider of non-utility related services and from second consumption data from a second provider of non-utility related services different from the first consumption data; and
(2) generate convergent billing information that reflects the quantity and price for each of the billable items; and
a master invoicing engine configured to generate an integrated invoice comprising consolidated billing information from the utilities billing information and the convergent billing information.

12. The system of claim 11 further comprising a database configured to store the consolidated billing information in one or more fields corresponding to one or more accounts of the consumer.

13. The system of claim 11 wherein the one or more billing units are further configured to:
generate a utilities billing document from the utilities billing information; and
generate a convergent billing document from the convergent billing information.

14. The system of claim 11 wherein the master invoicing engine is further configured to:
generate a subordinate document that stores references to the billing information; and
link the integrated invoice to the billing information referenced in the subordinate document.

15. The system of claim 14 wherein the master invoicing engine is further configured to:
link a header of the integrated invoice to a header of the subordinate document; and
store a document number of the convergent billing document in the integrated invoice header.

16. The system of claim 15 wherein the master invoicing engine is further configured to store a document number of the integrated invoice as a reference document number in the subordinate document header.

17. A non-transitory computer-readable storage medium comprising computer executable code, which when executed by a computer system, causes the computer system to perform operations for integrating billing streams from heterogeneous sources, the operations comprising:
receiving utility consumption data collected from a utility meter for utility related services of a utility services provider;
generating utilities billing information that reflects quantity and price of utilities consumed by a consumer based on the utility consumption data;
receiving consumption data for non-utility related services including first consumption data and second consumption data, wherein the first consumption data is for non-utility related services different from the second consumption data;
generating convergent billing information that reflects quantity and price for each billable item aggregated from the first and second consumption data; and
generating, using a master invoicing engine, an integrated invoice comprising consolidated billing information from the utilities billing information and the convergent billing information.

18. The computer-readable storage medium of claim 17 wherein the operations further comprise storing the consolidated billing information in one or more fields of a database corresponding to one or more accounts of the consumer.

19. The computer-readable storage medium of claim 17 wherein the operations further comprise:
generating a subordinate document that stores references to the convergent billing information; and
linking the integrated invoice to the billing information referenced in the subordinate document.

20. The computer-readable storage medium of claim 19 wherein the operations further comprise:
linking a header of the integrated invoice to a header of the subordinate document; and
storing a document number of the convergent billing document in the integrated invoice header.
